(19) United States
(12) Patent Application Publication
(10) Pub. No.: US 2019/0036129 A1
(43) Pub. Date: Jan. 31, 2019

(54) CARBON NANOFIBER CATALYST SUBSTRATE PRODUCTION PROCESS

(71) Applicant: Ford Global Technologies, LLC, Dearborn, MI (US)

(72) Inventors: Mark S. Sulek, Sterling Heights, MI (US); Kevin James Rhodes, Dearborn, MI (US); James A. Adams, Ann Arbor, MI (US); James Waldecker, Plymouth, MI (US)

(21) Appl. No.: 16/143,532

(22) Filed: Sep. 27, 2018

Related U.S. Application Data
(62) Division of application No. 14/991,366, filed on Jan. 8, 2016, now abandoned.

(51) Int. Cl. H01M 4/92; H01M 4/88; D01F 9/22; H01M 8/1004; H01M 8/0234; D01D 5/00; H01M 4/86; D01F 11/10; H01M 8/1018

(52) U.S. Cl. CPC H01M 4/926; H01M 4/8817; D01F 9/22; H01M 8/1004; H01M 8/0234; H01M 4/921; H01M 2250/20; D01D 5/0007; H01M 4/8807; H01M 4/8647; H01M 4/8626; D01F 11/10; H01M 2008/1095; H01M 4/8842

(57) ABSTRACT

A method of forming a fuel cell catalyst layer. The method includes spinning a composition including a base polymer, a solvent, and a catalyst precursor into a non-woven fiber mat having the catalyst precursor embedded therein. The method further includes carbonizing the non-woven fiber mat to form a carbon fiber substrate. The method also includes reacting the catalyst precursor to form a plurality of individual catalyst particles embedded in the carbon fiber substrate.

### CROSS-REFERENCE TO RELATED APPLICATIONS

This application is a division of application Ser. No. 14/991,366, filed Jan. 8, 2016, the disclosure of which is hereby incorporated in its entirety by reference herein.

### TECHNICAL FIELD

The present disclosure relates to processes for producing carbon nanofiber catalyst substrates, for example for proton exchange membrane fuel cells (PEMFC).

### BACKGROUND

Fuel cells, for example, hydrogen fuel cells, are one possible alternative energy source for powering vehicles. In general, fuel cells include a negative electrode (anode), an electrolyte, and a positive electrode (cathode). In a proton exchange membrane fuel cell (PEMFC), the electrolyte is a solid, proton-conducting membrane that is electrically insulating but allows protons to pass through. Typically, the fuel source, such as hydrogen, is introduced at the anode using a bipolar or flow field plate where it reacts with a catalyst and splits into electrons and protons. The protons travel through the electrolyte to the cathode and the electrons pass through an external circuit and then to the cathode. At the cathode, oxygen in air introduced from another bipolar plate reacts with the electrons and the protons at another catalyst to form water. One or both of the catalysts are generally formed of a noble metal or a noble metal alloy, typically platinum or a platinum alloy.

### SUMMARY

In one embodiment, a method of forming a fuel cell catalyst layer is disclosed. The method includes spinning a composition including a base polymer, a solvent, and a catalyst precursor into a non-woven fiber mat having the catalyst precursor embedded therein. The method further includes carbonizing the non-woven fiber mat to form a carbon fiber substrate. The method also includes reacting the catalyst precursor to form a plurality of individual catalyst particles embedded in the carbon fiber substrate.

In a second embodiment, a method of forming a fuel cell catalyst layer is disclosed. The method includes spinning a composition including a base polymer, a solvent, and a catalyst precursor into a non-woven fiber mat having the catalyst precursor embedded therein. The method further includes stabilizing the non-woven fiber mat to form a stabilized non-woven fiber mat. The method also includes carbonizing the stabilized non-woven fiber mat to form a carbon fiber substrate. The method further includes reacting the catalyst precursor to form a plurality of individual catalyst particles embedded in the carbon fiber substrate.

In yet a third embodiment, a method of forming a fuel cell catalyst layer is disclosed. The method includes spinning a composition including a base polymer, a solvent, and a catalyst precursor into a non-woven fiber mat having the catalyst precursor embedded therein. The method also includes carbonizing the non-woven fiber mat to form a carbon fiber substrate. The method further includes reacting the catalyst precursor to form a plurality of individual catalyst particles fully embedded in the carbon fiber substrate.

### BRIEF DESCRIPTION OF THE DRAWINGS

FIG. 1 is an exploded view of a proton exchange membrane fuel cell (PEMFC), according to an embodiment;

FIG. 2 is a cross-section of a PEMFC showing the components of the anode, cathode, and proton exchange membrane, according to an embodiment;

FIG. 3 is a schematic of an electrospinning system, according to an embodiment;

FIG. 4 is a schematic of an electrospun fiber catalyst substrate, according to an embodiment;

FIG. 5 is a flowchart of a method of forming a spun fuel cell catalyst layer, according to an embodiment;

FIG. 6 is a scanning transmission electron microscopy (STEM) image of an electrospun carbon nanofiber (CNF) catalyst substrate having platinum particles deposited thereon;

FIG. 7 is a STEM image of an electrospun carbon nanofiber (CNF) catalyst substrate having platinum particles embedded therein;

FIG. 8 is a graph showing rotating disk electrode (RDE) specific activity data for a standard catalyst, a non-embedded catalyst, and an embedded catalyst at the beginning of life (BOL), 7,500 cycles, and 15,000 cycles; and

FIG. 9 is a graph showing RDE mass activity data for a standard catalyst, a non-embedded catalyst, and an embedded catalyst at the BOL, 7,500 cycles, and 15,000 cycles.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

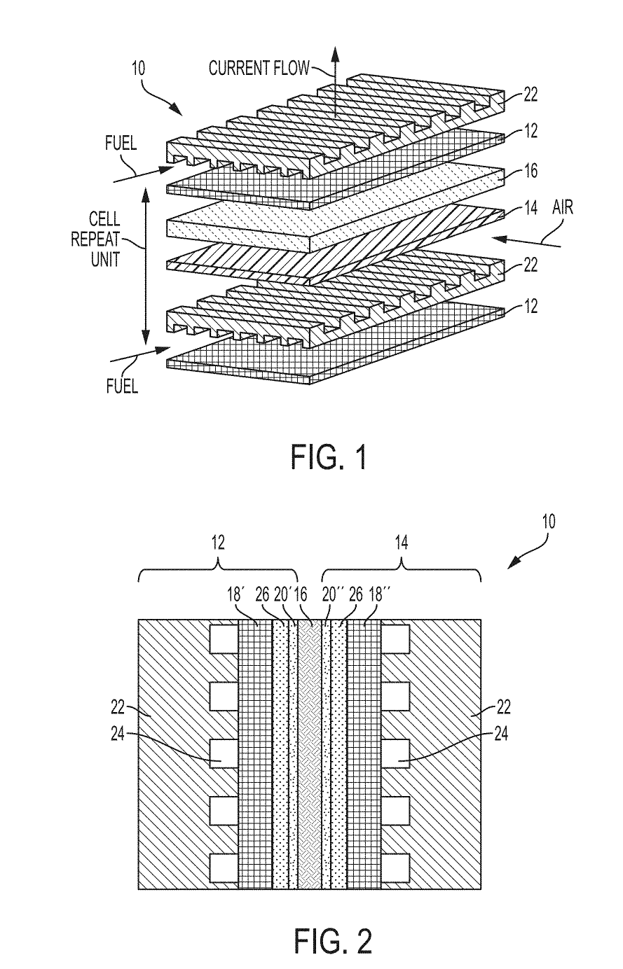

With reference to FIGS. 1 and 2, an example of a proton exchange membrane fuel cell (PEMFC) 10 is illustrated. The PEMFC 10 generally includes a negative electrode (anode) 12 and a positive electrode (cathode) 14, separated by a proton exchange membrane (PEM) 16 (also a polymer electrolyte membrane). The anode 12 and the cathode 14 may each include a gas diffusion layer (GDL) 18, a catalyst layer 20, and a bipolar or flow field plate 22 which forms a gas channel 24. The catalyst layer 20 may be the same for the anode 12 and the cathode 14, however, the anode 12 may have a catalyst layer 20′ and the cathode 14 may have a different catalyst layer 20″. The catalyst layer 20′ may facilitate the splitting of hydrogen atoms into hydrogen ions and electrons while the catalyst layer 20″ facilitates the reaction of oxygen gas, hydrogen ions, and electrons to form water. In addition, the anode 12 and cathode 14 may each include a microporous layer (MPL) 26 disposed between the GDL 18 and the catalyst layer 20.

The PEM 16 may be any suitable PEM known in the art, such as a fluoropolymer, for example, Nafion (a sulfonated tetrafluoroethylene based fluoropolymer-copolymer). The GDL 18 may be formed of materials and by methods known in the art. For example, the GDL 18 may be formed from carbon fiber based paper and/or cloth. GDL materials are generally highly porous (having porosities of about 80%) to allow reactant gas transport to the catalyst layer (which generally has a thickness of about 10-15 μm), as well as liquid water transport from the catalyst layer. GDLs may be treated to be hydrophobic with a non-wetting polymer such as polytetrafluoroethylene (PTFE, commonly known by the trade name Teflon). A microporous layer (MPL) may be coated to the GDL side facing the catalyst layer to assist mass transport. The MPL may be formed of materials and by methods known in the art, for example, carbon powder and a binder (e.g., PTFE particles). The catalyst layer 20 may include a noble metal or a noble metal alloy, such as platinum or a platinum alloy. The catalyst layer may include a catalyst support, which may support or have deposited thereon a catalyst material.

The bipolar plates 22 may have channels 24 defined therein for carrying gases. The channels 24 may carry air or fuel (e.g., hydrogen). As shown in FIG. 1, the plates 22 and channels 24 may be rotated 90 degrees relative to each other. Alternatively, the plates 22 and channels may be oriented in the same direction. Bipolar plate materials need to be electrically conductive and corrosion resistant under proton exchange membrane fuel cell (PEMFC) operating conditions to ensure that the bipolar plate perform its functions—feeding reactant gases to the membrane electrode assembly (MEA) and collecting current from the MEA.

In conventional PEMFCs, the catalyst layer typically includes platinum supported on carbon particles, such as carbon black. Carbon-supported platinum catalysts have been discovered to experience difficulties with durability, at least partially due to carbon corrosion and platinum agglomeration. One approach to reducing carbon corrosion may be to use graphitic carbon, which has lower surface area and is less susceptible to carbon corrosion. However, lower surface area may reduce the access of gases in the fuel cell to the catalyst. In addition, graphitic carbon may be more susceptible to platinum agglomeration, which reduces the surface area of the platinum and therefore the activity of the catalyst.

Accordingly, to make graphitic carbon an effective catalyst substrate, the agglomeration or coalescence of the platinum particles may need to be improved. It has been discovered that one approach to preventing or reducing Pt coalescence may be improving the anchoring strength of the platinum to the carbon structure. It has also been discovered that functionalization on the carbon may improve Pt anchoring and dispersion of Pt nanoparticles. One approach to functionalization may be incorporation of oxygen or nitrogen-containing functionalities onto the graphitic surface to improve interfacial adhesion.

It has been discovered that spinning (e.g., electrospinning) of catalyst support or substrate materials may provide the ability to encapsulate or embed the catalyst materials (e.g., Pt, Pd, or alloys thereof) and thereby prevent or reduce catalyst material agglomeration or coalescence and increase the anchoring and dispersion of the catalyst material. The spun catalyst support may then be stabilized and carbonized into carbon nanofibers (e.g., graphene wrapped into stacked cones, cups, plates, or cylinders). The spun carbon nanofiber (CNF) catalyst substrate may therefore provide the benefits of graphitic carbon, such as reduced carbon corrosion, but without the increased agglomeration of the catalyst material.

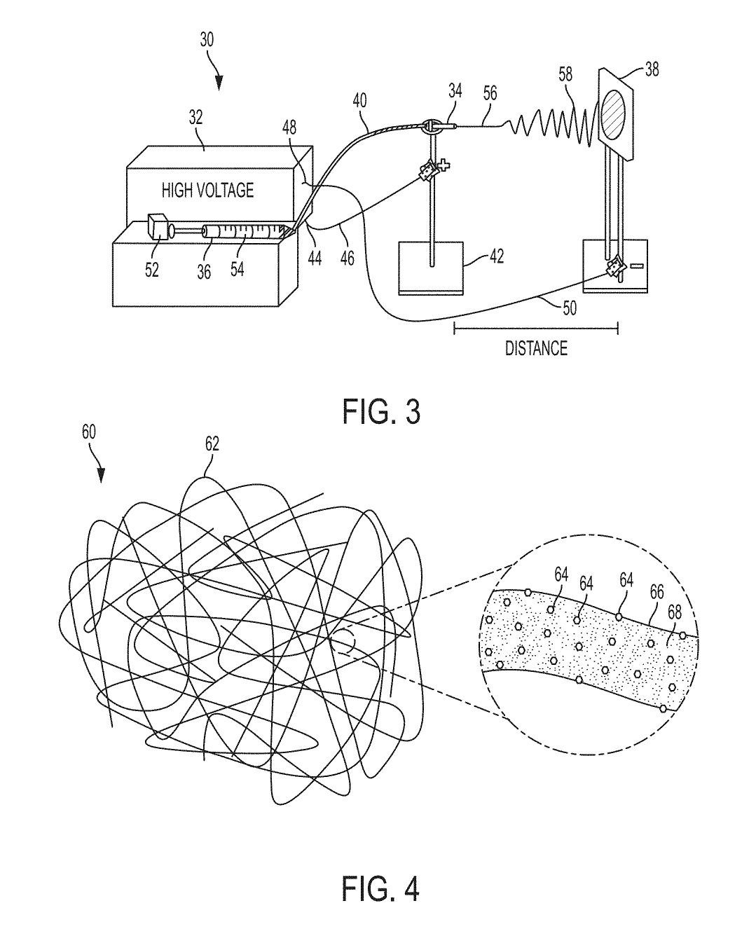

Accordingly, with respect to FIGS. 3-5, a method of preparing an electrospun catalyst substrate and a catalyst substrate prepared therefrom are disclosed. The general process of electrospinning is known in the art and will not be described in great detail. In brief, electrospinning includes applying a high voltage (e.g., 5-50 kV) to a droplet of polymer solution or melt, thereby inducing a strong charging effect on the fluid. At a certain charge level, electrostatic repulsion overcomes the surface tension of the liquid and the droplet is stretched until a stream of liquid is ejected from the droplet. The point of ejection is known as a Taylor cone. Molecular cohesion causes the stream to stay together, such that a charged liquid jet is formed. The liquid jet begins to solidify in the air, at which point the charge in the liquid migrates to the surface of the forming fiber. Small bends in the fiber lead to a whipping process caused by electrostatic repulsion. The whipping process elongates and narrows the fibers. The resulting fibers may have an average diameter (e.g., a uniform fiber diameter) of 10 to 100's of nm, such as 10 to 500 nm, 10 to 300 nm, 50 to 300 nm, or 100 to 300 nm. The fiber diameter may vary based on the spinning parameters/variables, such as voltage, fluid viscosity, solvent composition, ambient temperature and humidity, and distance from spinner head to collector.

FIG. 3 is a schematic generally describing the electrospinning process and equipment. The electrospinning system 30 generally includes a power supply 32, which may be a high voltage DC power supply (e.g., 5 to 50 kV), a spinneret 34, a syringe 36 and a collector 38. The spinneret 34 may be a hypodermic syringe needle or other narrow, hollow tube structure. The spinneret 34 may be directly attached to the syringe 36 or may be connected by a tube or hose 40. The spinneret may by supported by a stand 42, which may be configured to hold the spinneret 34 at a certain position relative to the collector 38 (e.g., height, horizontal distance, angle). The spinneret 34 or the stand 42 may be electrically connected to a positive terminal 44 of the power supply 32 by a wire 46 and the collector 38 may be electrically connected to a negative terminal 48 of the power supply 32 by a wire 50. Alternatively, the collector 38 may be grounded. The collector 38 may take several forms, such as a stationary plate, a rotating drum, or conveyor belt.

During the electrospinning process, a polymer solution, sol-gel, particulate suspension, or melt may be loaded into the syringe 36, which may then be actuated by a pump 52 to force the polymer liquid 54 into and through the spinneret 34, generally at a constant rate. Alternatively, the polymer liquid 54 may be fed to the spinneret from a tank under constant pressure. The liquid is charged at the spinneret 34 and forms a jet 56, as described above. As the jet 56 solidifies, it whips into a fiber 58 and is collected on the collector 38. The result of the electrospinning process may be a nonwoven web or mesh of nanofibers. A variety of factors or parameters can affect the size and properties of the resulting fibers 58, including the molecular weight, polydispersity index, and type of the polymer, solution concentration, the liquid properties (e.g., viscosity, conductivity, and surface tension), the electric potential and flow rate, the distance between the spinneret 34 and the collector 38, ambient conditions (e.g., temperature and humidity), the motion and/or size of the collector 38, and the gauge of the needle or tube in the spinneret 34.

In at least one embodiment, the composition or material loaded into the system 30 may include a catalyst substrate material. The catalyst substrate material may include a base polymer and a solvent capable of dissolving the base polymer. In one embodiment, the base polymer is polyacrylonitrile (PAN), a PAN co-polymer, or a PAN-derivative. A suitable solvent for PAN may include dimethylformamide (DMF). In addition to PAN, other base materials that can be heat treated to form stable, carbonized fibers without melting may be used. Non-limiting examples may include cellulose, polyvinyl alcohol, polyvinyl chloride, and polystyrene. DMF or other suitable solvents may be used for these base materials.

In one embodiment, in addition to the solvent there may be another liquid component included in the catalyst substrate material, such as water, that is not miscible with the solvent. The addition of the immiscible liquid may cause the electrospun fibers themselves to have a porous structure (e.g., as opposed to the highly porous overall substrate). The porous structure may be an open porous structure having interconnected pores. An open porous structure may further increase the access of gases to the catalyst particles. Without being held to any particular theory, it is believed that a mixture of solvent and another immiscible liquid (e.g., water) may cause the electrospun fibers to have pores formed therein during the electrospinning process. The pores may be formed as a result of a phase inversion between the solvent and the water (or other immiscible liquid).

The composition of the solvent and the immiscible liquid mixture may be varied to adjust the average pore size formed in the electrospun fibers and/or the overall porosity of the fibers. In one embodiment, the solvent may comprise the majority of the mixture (e.g., >50% by weight). In another embodiment, the immiscible liquid may comprise 0.5 to 25 wt. % of the mixture, with the balance being solvent, or any sub-range therein. For example, the immiscible liquid may comprise 0.5 to 20 wt. %, 0.5 to 15 wt. %, 1 to 15 wt. %, 2 to 15 wt. %, or 2 to 12 wt. %, with the balance being solvent. In general, the overall porosity of the electrospun fibers may increase with a greater amount of the immiscible liquid in the mixture. The impact on pore size based on the amount of the immiscible liquid may depend on the solvent and immiscible liquid used.

After the spinning process is completed and a nonwoven web or mesh of spun fibers is formed, the fibers may be processed into carbon nanofibers (CNF). The conversion of the spun fibers into CNF may be a two-step process including stabilization and carbonization. These steps are known to those of ordinary skill in the art and will not be described in detail. Stabilization generally includes heating the fibers to a temperature of 200 to 300° C. (e.g., about 280° C.) for several minutes to several hours (e.g., 0.2 to 4 hours). Stabilization may be performed in air. Carbonization generally includes heating the stabilized fibers to a temperature of at least 800° C., for example, at least 850° C., 900° C., or 1,000° C. The heat treatment may be for at least one minute or several minutes (e.g., 1 to 60 minutes). Carbonization is generally performed in an inert environment, such as nitrogen or argon. During carbonization, non-carbon atoms are removed from the fibers and the carbon atoms arrange in a structured pattern (e.g., graphene). While the conversion of spun fibers to CNF is described as a two-step process, other suitable methods of conversion known in the art may be used. For example, a single-step process or a process having three or more steps (e.g., including a two-step carbonization step).

Catalyst material, such as platinum, palladium, other noble metals, alloys thereof, or metal oxides that enhance activity or durability may be incorporated into or onto the electrospun fibers before and/or after the spinning process. In at least one embodiment, the catalyst material may be included in the solution or material loaded into the spinning system 30 (e.g., included with the catalyst substrate material). The catalyst material may be included in its final form (e.g., nanoparticles) or as a precursor. In one embodiment, the catalyst material is platinum (e.g., pure or metallic platinum). In embodiments where the catalyst material is included in the spinning solution as a precursor, the precursor may include a compound that is readily converted into the final catalyst by a later reaction (e.g., oxidation or reduction). In one embodiment, chloroplatinic acid (H₂PtCl₆) may be used as a platinum catalyst precursor. Therefore, in one example, chloroplatinic acid may be included in the catalyst substrate material along with the base polymer (e.g., PAN), solvent (e.g., DMF), and optional immiscible liquid (e.g., water), or any other components.

During the spinning process, the catalyst precursor, such as chloroplatinic acid, may become embedded in and/or attached to the spun fibers. To convert the catalyst precursor into a final catalyst material, such as nanoparticles, a reagent may be introduced or applied to the spun fibers in order to react with the catalyst precursor. Any suitable reagent may be used that will convert the catalyst precursor into the final catalyst material (e.g., metallic platinum). The reagent may reduce or oxidize the precursor to form the final catalyst material. In one embodiment, the reagent may reduce the precursor. One example of a reagent may be hydrogen. For example, hydrogen may be used to reduce chloroplatinic acid to form metallic platinum. The conversion of the precursor to the final catalyst material may be performed before or after the stabilization/carbonization process. In one embodiment, the conversion is performed after.

An example of a catalyst layer 60 including an electrospun CNF fiber substrate 62 having embedded catalyst particles 64 is shown in FIG. 4. The catalyst substrate 62 may be a non-woven web, mat, or mesh. As shown in the enlarged view, the catalyst substrate 62 may have catalyst particles 64 embedded therein. The catalyst substrate 62 may have an outer surface portion 66 and a bulk or interior portion 68 that is bounded by the surface portion 66. Accordingly, at least a portion of the particles 64 may be disposed or embedded completely within the bulk portion 68 of the substrate 62, in addition to a portion being located at the surface 66 of the fibers. In at least one embodiment, a significant portion of the particles 64 may be embedded in the bulk portion 68. In one embodiment, the particles 64 embedded in the bulk 68 may outweigh and/or outnumber the particles 64 embedded or disposed on the surface portion 66. A ratio of the weight or number of bulk portion particles to the surface portion particles may be at least 1:3, for example, at least 1:2, 1:1, or 2:1 (e.g., at least 25%, 33.3%, 50%, or 66.7%). The particles 64 may be spaced apart, for example they may be evenly distributed throughout the bulk portion 68 of the substrate 62. The embedded particles 64 may therefore be anchored within the substrate 62 and prevented or inhibited from migrating during fuel cell operation. This may prevent or reduce the amount of agglomeration of the catalyst material, thereby maintaining high catalyst surface area and activity. In embodiments where an immiscible liquid is added to the electrospinning mixture, there may be added porosity in the substrate 62. These pores may facilitate increased gas diffusion to the embedded particles 64, which may increase the catalytic activity of that catalyst layer 60.

In some embodiments, the catalyst material may be deposited onto the catalyst substrate after the spinning process. The catalyst material may be deposited onto the catalyst substrate directly in its final form (e.g., metallic platinum) or using a precursor. Similar to the embedded embodiments, the precursor may include a compound that is readily converted into the final catalyst by a reaction (e.g., oxidation or reduction), which may occur substantially simultaneously with the deposition or in a later step. In one embodiment, chloroplatinic acid (H₂PtCl₆) may be used as a platinum catalyst precursor. In one embodiment, chloroplatinic acid may be deposited onto the catalyst substrate surface. For example, chloroplatinic acid may be deposited and reduced through a wet chemistry technique using a reducing agent, such as hydrogen or ethylene glycol.

To convert the catalyst precursor into a final catalyst material, such as nanoparticles, a reagent may be introduced or applied to the catalyst substrate in order to react with the catalyst precursor. The reagent may be introduced substantially simultaneously with the deposition or the precursor or in a later step. Any suitable reagent may be used that will convert the catalyst precursor into the final catalyst material (e.g., metallic platinum). The reagent may reduce or oxidize the precursor to form the final catalyst material. In one embodiment, the reagent may reduce the precursor. One example of a reagent may be hydrogen. For example, hydrogen may be used to reduce chloroplatinic acid to form metallic platinum. The deposition and conversion of the precursor to the final catalyst material may be performed before or after the stabilization/carbonization process. In one embodiment, the conversion is performed after.

The catalyst particles, whether embedded or on the surface, may be formed as nanoparticles (e.g., with a width/diameter of less than 100 nm). In one embodiment, the nanoparticles may have an average width or diameter of less than 50 nm or less than 25 nm. For example, the nanoparticles may have an average width/diameter of 1 to 20 nm, or any sub-range therein, such as 1 to 15 nm, 1 to 12 nm, 2 to 12 nm, 2 to 10 nm, 4 to 10 nm, 5 to 10 nm, 6 to 10 nm, 2 to 8 nm, or 2 to 6 nm.

In at least one embodiment, the catalyst nanoparticles are formed of platinum, palladium, or other noble metals or alloys thereof. In one embodiment, the nanoparticles are pure or metallic elements, such as platinum. The catalyst material (e.g., nanoparticles) may comprise 5 to 50 wt. % of the catalyst layer, or any sub-range therein. For example, the catalyst material may comprise 10 to 40 wt. %, 15 to 40 wt. %, 15 to 35 wt. %, 20 to 35 wt. %, 15 to 30 wt. %, or 20 to 30 wt. % of the catalyst layer.

The catalyst layer may be an anode-side catalyst layer and/or a cathode-side catalyst layer. Use on either side may have benefits over current catalyst layers. For example, the catalyst layer may be beneficial on the cathode to take advantage of its activity for oxygen reduction, while on the anode side it may increase the resistance of the nanofibers to corrosion under conditions, such as hydrogen starvation. The catalyst layer may have a thickness of 2 to 20 μm, or any sub-range therein. For example, the catalyst layer may have a thickness of 3 to 15 μm, 5 to 12 μm, 5 to 10 μm, or about 8 μm (e.g., ±2 μm). The disclosed catalyst layers (e.g., embedded or surface nanoparticles) may have a greater specific and/or mass activity, compared to conventional carbon black and platinum catalyst layers (e.g., TKK-EA50E). Specific activity measures the catalytic activity of the catalyst per unit area of the catalyst (e.g., Pt), while mass activity measures the catalytic activity of the catalyst per unit mass of the catalyst.

In one embodiment, the disclosed catalyst layers may have a specific activity of at least 0.4 mA/cm2 at the beginning of life (BOL) of the fuel cell. For example, the catalyst layer may have a specific activity of at least 0.5, 0.7, 0.9, or 1.0 mA/cm2 at the BOL. In some embodiments, the specific activity may increase over the life of the fuel cell, for example, at 7,500 cycles or 15,000 cycles. The specific activity may increase to at least 1.3 mA/cm2 at 7,500 or 15,000 cycles. In another embodiment, the disclosed catalyst layers may have a mass activity of at least 200 A/g(Pt) at the beginning of life (BOL) of the fuel cell. For example, the catalyst layers may have a mass activity of at least 250 or 300 A/g(Pt) at the BOL.

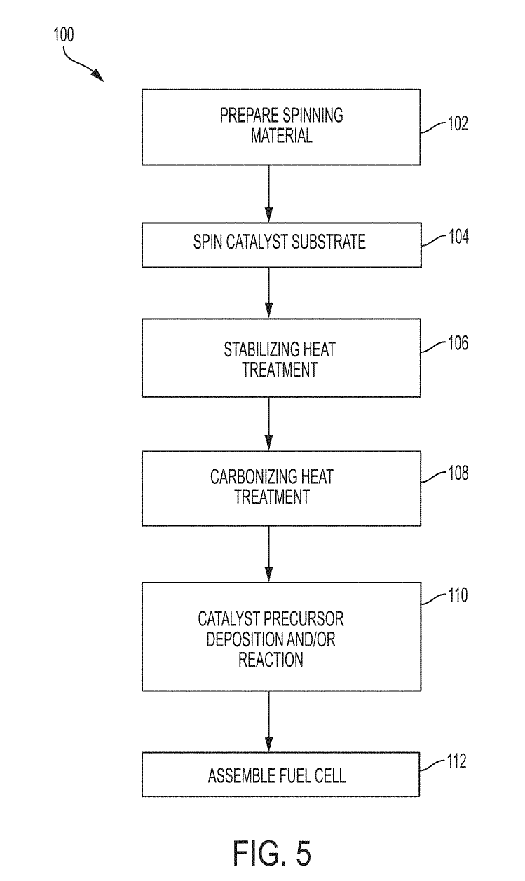

With reference to FIG. 5, a flowchart 100 is shown for an embodiment of a method of forming a catalyst layer including catalyst nanoparticles. In step 102, the material to be spun is prepared. As described above, the material to be spun may include a base polymer and a solvent capable of dissolving the base polymer. The base polymer may be PAN, a PAN co-polymer, or a PAN-derivative, or other base materials that can be heat treated to form stable, carbonized fibers. The solvent may be DMF, or another suitable solvent. As described above, an additional immiscible liquid may be added to the solvent to generate porosity in the spun fibers. In embodiments where the catalyst material is to be embedded, the spinning material may also include a catalyst precursor, such as chloroplatinic acid (H₂PtCl₆).

In step 104, the spinning material may be spun into a fiber catalyst substrate. The fibers may be nanofibers. The spinning may be electrospinning and may form a non-woven web, mesh, or mat. In step 106, the substrate may be heat treated to stabilize the fibers and in step 108, the substrate may be heated at a second, higher temperature to carbonize the fibers. Steps 106 and 108 may be combined into a single step or steps 106 and/or 108 may be split into additional steps depending on the heat treatment schedule.

In step 110, the catalyst precursor may be deposited or deposited and reacted, depending on the type of catalyst substrate being formed. In embodiments where the catalyst precursor is included in the spinning material, step 110 may only include a reaction step to convert the catalyst precursor into the final catalyst material (e.g., nanoparticles). In embodiments where the catalyst precursor is not included in the spinning material, step 110 may include depositing the precursor onto the substrate and a reaction step to convert the catalyst precursor into the final catalyst material. As described above, the deposition and reaction processes may be simultaneous or near simultaneous in the latter embodiments. The reaction step in either embodiments may include oxidizing or reducing the precursor. For example, the precursor (e.g., chloroplatinic acid) may be reduced using hydrogen to form catalyst nanoparticles. If the precursor is included in the spinning material, then the reaction step may form embedded catalyst particles within the fiber substrate. If the precursor is deposited and reacted after the spinning step, the catalyst particles may be attached to the surface of the fiber substrate.

In step 112, the catalyst layer including the fiber catalyst substrate and catalyst material may be incorporated into a fuel cell. As described above, the catalyst layer may be included in the anode and/or cathode of the fuel cell. If the catalyst layer is included in both, steps 102-110 may be repeated for each electrode. The other components of the fuel cell are described above and the assembly of a fuel cell is known to those of ordinary skill in the art and will not be described in detail. While the catalyst layer has been described in the context of a PEMFC (e.g., hydrogen-based), the layer may also be used for other types of fuel cells or for other applications where a fiber substrate having catalyst material embedded and/or deposited thereon may be beneficial. For example, the layer may be used for batteries (e.g., rechargeable batteries) or capacitors. As described above, the catalyst substrate may be in the form of a non-woven mat. However, in another embodiment, the catalyst substrate may be ground up into small pieces and used in a catalyst ink. In this embodiment, the CNF may still have the same embedded and/or surface catalyst particles, but may be in discrete lengths that are shorter than the originally spun fibers.

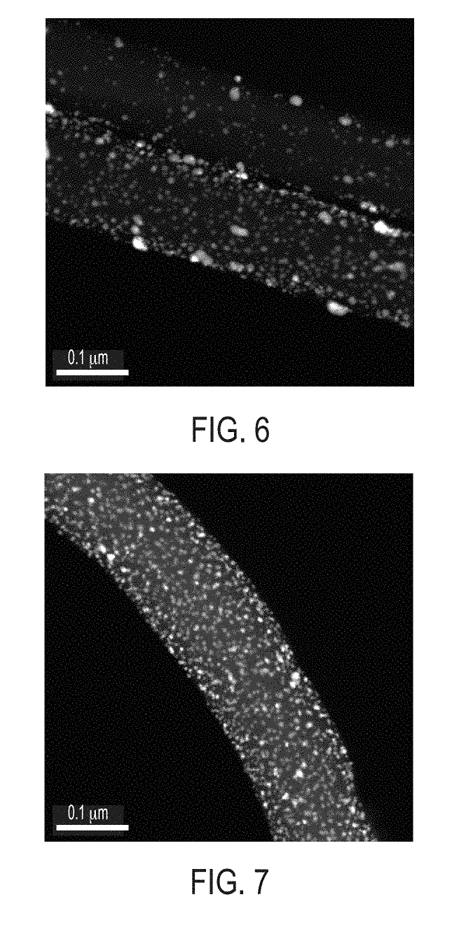

With reference to FIGS. 6 and 7, examples of images for an embedded and a deposited catalyst substrate are shown. FIG. 6 shows a scanning transmission electron microscopy (STEM) image of an electrospun CNF having platinum deposited thereon. The fiber was electrospun from PAN and DMF without a platinum precursor in the spinning material. The fiber was then stabilized and carbonized before chloroplatinic acid was deposited and simultaneously reduced using hydrogen to form platinum nanoparticles on the fiber surface. The Pt particles had an average diameter of 6.54 nm and the Pt particles comprised about 20 wt. % of the catalyst substrate. FIG. 7 shows a STEM image of an electrospun CNF having platinum embedded therein. The fiber was electrospun from PAN and DMF with a chloroplatinic acid platinum precursor included in the spinning material. The fiber was then stabilized and carbonized before the chloroplatinic acid was reduced using hydrogen to form platinum nanoparticles embedded in the fiber. The Pt particles had an average diameter of 8.46 nm and the Pt particles comprised about 15 wt. % of the catalyst substrate. As shown, the Pt particles are evenly disbursed throughout the fiber.

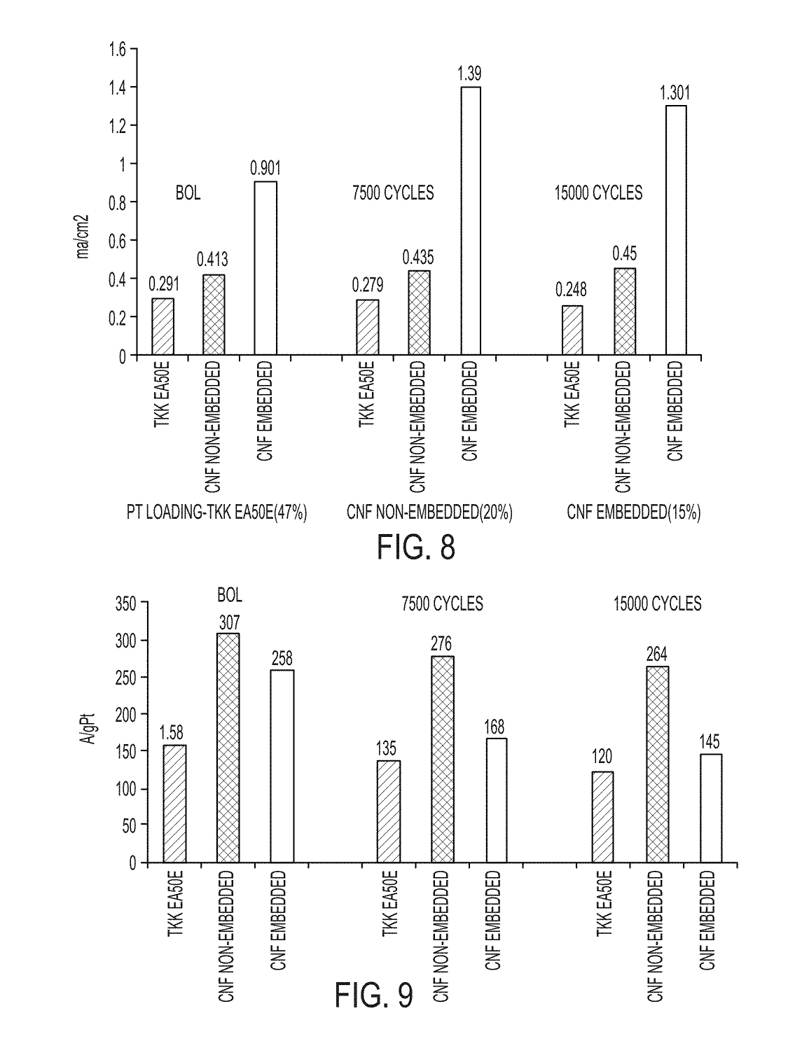

With reference to FIGS. 8 and 9, experimental data is shown for the catalyst substrates in FIGS. 6 and 7. The performance of the embedded and non-embedded Pt catalyst layers were compared to an industry standard catalyst (TKK-EA50E) using a rotating disk electrode (RDE) at the beginning of life (BOL), 7,500 cycles, and 15,000 cycles. The standard catalyst had 47 wt. % Pt loading, while the non-embedded had 20 wt. % and the embedded had 15 wt. %. Both the embedded and non-embedded catalyst layers outperformed the standard catalyst in specific and mass activity at all cycle numbers. As shown in FIG. 8, the embedded catalyst layer showed greatly increased specific activity over the non-embedded catalyst layer, which in turn had greatly increased specific activity over the standard catalyst. While the specific activity of the standard catalyst decreased over time, the non-embedded catalyst layer improved slightly at each stage. The embedded catalyst layer improved substantially from BOL to 7,500 cycles and then decreased slightly from 7,500 to 15,000 cycles (but still significantly above BOL). The mass activities of all three catalyst layers decreased over time, with the activity levels going in order from non-embedded, embedded, to standard.

Spun catalyst substrates having improved activity and reduction in catalyst agglomeration are disclosed. In some embodiments, precursors of the catalyst material (e.g., Pt) may be spun into the fibers of the substrate and later reacted to form embedded catalyst particles (e.g., nanoparticles) in the catalyst substrate fibers. The embedded particles may be inhibited from migrating over time, thereby reducing or preventing agglomeration of the catalyst material during continual cycling of the fuel cell. The embedded catalyst layer provides very high specific activity, particularly compared to standard carbon black substrates. Porosity may be introduced into the spun fibers to further facilitate gas transport and access to the catalyst material that is embedded in the fibers.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of forming a fuel cell catalyst layer comprising:
spinning a composition including a base polymer, a solvent, and a catalyst precursor into a non-woven fiber mat having the catalyst precursor embedded therein;
carbonizing the non-woven fiber mat to form a carbon fiber substrate; and
reacting the catalyst precursor to form a plurality of individual catalyst particles embedded in the carbon fiber substrate.

2. The method of claim 1, wherein the composition further includes an immiscible liquid that is not miscible with the solvent.

3. The method of claim 2, wherein the carbon fiber substrate is comprised of a plurality of carbon nanofibers, and each carbon nanofiber has a porous structure.

4. The method of claim 2, wherein the immiscible liquid is comprised of water.

5. The method of claim 2, wherein greater than 50% by weight of a mixture of the solvent and immiscible liquid is the solvent.

6. The method of claim 1, wherein the base polymer is polyacrylonitrile (PAN), a PAN co-polymer, or a PAN-derivative.

7. The method of claim 1, wherein the plurality of individual catalyst particles are formed of metallic platinum.

8. A method of forming a fuel cell catalyst layer comprising:
spinning a composition including a base polymer, a solvent, and a catalyst precursor into a non-woven fiber mat having the catalyst precursor embedded therein;
stabilizing the non-woven fiber mat to form a stabilized non-woven fiber mat;
carbonizing the stabilized non-woven fiber mat to form a carbon fiber substrate; and
reacting the catalyst precursor to form a plurality of individual catalyst particles embedded in the carbon fiber substrate.

9. The method of claim 8, wherein the composition further includes an immiscible liquid that is not miscible with the solvent.

10. The method of claim 9, wherein the carbon fiber substrate is comprised of a plurality of carbon nanofibers, and each carbon nanofiber has a porous structure.

11. The method of claim 9, wherein the immiscible liquid is comprised of water.

12. The method of claim 9, wherein greater than 50% by weight of a mixture of the solvent and immiscible liquid is the solvent.

13. The method of claim 8, wherein the base polymer is polyacrylonitrile (PAN), a PAN co-polymer, or a PAN-derivative.

14. The method of claim 8, wherein the plurality of individual catalyst particles are formed of metallic platinum.

15. A method of forming a fuel cell catalyst layer comprising:
spinning a composition including a base polymer, a solvent, and a catalyst precursor into a non-woven fiber mat having the catalyst precursor embedded therein;
carbonizing the non-woven fiber mat to form a carbon fiber substrate; and
reacting the catalyst precursor to form a plurality of individual catalyst particles fully embedded in the carbon fiber substrate.

16. The method of claim 15, wherein the catalyst precursor is comprised of chloroplatinic acid.

17. The method of claim 15, wherein the reacting step includes reacting the catalyst precursor with a reagent to form the plurality of individual catalyst particles.

18. The method of claim 17, wherein the reagent is hydrogen.

19. The method of claim 15, wherein the carbon fiber substrate is comprised of a plurality of carbon nanofibers.

20. The method of claim 19, wherein each of the carbon nanofibers includes interconnected open pores.
